(19) United States
(12) Patent Application Publication
(10) Pub. No.: US 2007/0249321 A1
(43) Pub. Date: Oct. 25, 2007

(54) SYSTEM FOR A WIRELESS INTELLIGENT SERVICES ENGINE

(75) Inventors: G. V. Kumar, Hyderabad (IN); S. Mohan Kumar, Hyderabad (IN)

Correspondence Address: OBLON, SPIVAK, MCCLELLAND, MAIER & NEUSTADT, P.C., 1940 DUKE STREET, ALEXANDRIA, VA, 22314, US

(73) Assignee: Megasoft Consultants, Inc., Herndon, VA (US)

(21) Appl. No.: 11/697,286

(22) Filed: Apr. 5, 2007

Related U.S. Application Data
(63) Continuation of application No. 10/558,242.
Application No. 10/558,242 is a continuation of application No. 10/850,561, filed on May 21, 2004, now abandoned.
(60) Provisional application No. 60/472,716, filed on May 23, 2003.

(51) Int. Cl. H04M 11/00

(52) U.S. Cl. 455/406

(57) ABSTRACT

A system that integrates the services offered by providers in the wireless communication industry. The system provides a seamless, efficient and realtime way to connect wireless communication services with other associated services, such as billing and rating engines. Additionally, the system is fully customizable and applicable with general industry standards. The system is also expandable and upgradable without the need to replace the overall infrastructure of the provider. The system, therefore, reduces the administrative costs related to billing and reduces the capital costs related to upgrading and maintaining the core infrastructure of the provider.

### BACKGROUND OF THE INVENTION

1. Field of the Invention

The present invention relates to a system that enhances revenue and reduces costs by integrating services associated with the wireless communication industry.

2. Background of the Technology

Wireless communication, such as cellular or digital telephone communication, is widespread and continues to grow and evolve rapidly. Providers (interchangeably referred to herein as “carriers” or “operators”) in the wireless communication industry have an enormous task of providing seamless wireless communications to end parties (interchangeably referred to herein as “users” or “consumers”). The wireless communication systems, which form the technological foundation of the wireless communication industry, however, are not currently able to provide operators with the scope of integrated functions needed to keep up with the demands of the industry.

For instance, one significant problem faced by the wireless communication Industry is integrating signaling services (those that specifically provide wireless communication), with administrative services, such as billing and revenue management. The administrative services are typically managed by operations support systems (OSS) (interchangeably referred to herein as the “platform”), which are generally systems that process information supporting various management functions, such as billing, customer care, network management, inventory control, maintenance, trouble ticket reporting, surveillance and service provisioning.

The current technology in the wireless communication field is increasingly encumbered by legacy operating systems that were developed with a compartmentalized, functional view of the providers operations. Thus, billing systems are developed in isolation from the network, and signaling plays a limited role in service creation. The net results are highly capable and robust OSS systems that perform well within a limited functional sphere of capabilities. Carriers typically spend great time and resources in bringing these different operational systems into a harmonious optimal relationship. As long as OSS and billing providers continue to take a narrow and compartmentalized perspective to system design, architecture, and performance, sub-optimization will be the norm.

There is an increased awareness and demand for a more integrated OSS and network capabilities. Carriers are increasingly frustrated in being presented with dysfunctional systems that require extensive modifications before they can fully operate. The cost to the carrier can be incurred not only in terms of additional adaptation costs, but also in lost revenues as new service creation is delayed.

Wireless carriers are also demanding greater real, or near real-time, capabilities in the areas of real time service creation, quality of service optimization, and cost performance management from their OSS/Billing providers. The pressure on carriers to reduce costs, increase return on investment, and increase profitability has never been more severe.

For example, providers typically use numerous applications and platforms to carry out the plethora of services used by providers. This approach is inherently flawed and creates disadvantages for the provider mainly because this approach often limits the breadth of the applications. For instance, each application or platform used by the provider is focused on a specific task, thereby forcing the provider to compartmentalize activity. Compartmentalization is believed to be a narrow and inefficient method of addressing the activities of the provider.

Providers are increasingly growing frustrated with the reality of losses in revenue and the lack of available, easy-to-use remedies. For example, currently used technologies attempt to connect the multitude of services offered by providers by implementing extensive modifications to and upgrades of existing systems. This method of upgrading is not generally efficient; rather it has proven to be cost prohibitive due to the high costs associated with system testing, adaptation, and implementation. Moreover, this type of upgrade is commonly associated with numerous delays (due in part to the difficulty synchronizing older systems with newer applications. Delays usually account for significant revenue loss.

The present state of the technology also does not facilitate real-time processing. In particular, providers are limited in the areas of real-time service assessment and integration, quality of service optimization, and cost performance management. The inability to make real-time decisions and optimizations has an effect on the providers' revenue stream. For instance, in some cases, optimizations necessary to capture revenue are not implemented until a significant portion of available revenue is already lost.

It is widely believed, for example, that providers fail to collect significant amounts of revenue and that providers have unnecessary overhead that contributes to overall costs of operation. Accordingly, it is believed that providers suffer these losses of revenue, in part, because of 1) an inability of the present technology to accurately assess and collect revenue based on signaling or network use and 2) an inefficient method of processing revenue streams.

Thus, there remains an unmet need in the prior art for an elegant, intelligent and efficient wireless communication system that provides a wireless carrier with a single OSS platform integrating and implementing multiple systems, services, solutions and applications from third party technology vendors. There also remains an unmet need in the art for an OSS platform that facilitates upgrades, customization, and general usability, while providing an enhancement for revenue collection and cost reduction of services associated with network operation.

### SUMMARY OF THE INVENTION

The present invention provides an underlying platform layer that can remain a static core on which newer and newer applications can be built, and innovative services can be launched, without having to replace high cost capital infrastructure again and again, as technology matures. Products, services, and applications can become obsolete, but the capital infrastructure should not necessarily become obsolete as well.

Two core elements, which provide the underlying logic for all services—old and new—for the last 20 years and do not change for wireless carriers, are signaling and billing. The present invention provides one such pioneering technology platform and layer, which uniquely combines signaling protocols and real-time rating engines to form a core on which applications can rest. The present invention uses signaling to transmit data, probe network operations, and distribute information in real time, thus creating innovative services, while seamlessly combining rating engines and billing elements to charge for these services in real time.

The present invention, which in one embodiment is referred to as the wireless intelligent services engine (WISE) (also interchangeably referred to herein as the “system”), may also provide a robust, multi-layer OSS platform that integrates the numerous services offered by a provider into an operational system. WISE assists providers to maximize revenues and to reduce costs. In particular, the present invention provides a single, advanced real-time and integrated signaling and billing system, which forms the basis for all wireless communications services and associated services. The system integration is provided through the OSS platform, which incorporates signaling protocols to transmit data (e.g., via signaling system 7 (SS7) or C-7 signaling), the probing of network operations, and the distribution of information in real-time. As a result, the system of the present invention seamlessly allows the providers' rating engines and billing elements to charge for communication services in real-time.

In one more aspect of the present invention, the present invention increases the general application and usability of the operation system, in comparison to conventional operating systems. In particular, the system of the present invention is designed to be easily implemented, customized, and upgraded.

The system allows providers to efficiently and cost-effectively implement the system. The system does not require extensive modifications before the system is fully operational, thereby saving the provider from high implementation costs and delays that are typically associated with application upgrades. Moreover, the system can be customized to accommodate the needs of each provider. Thus, the present invention is highly scaleable and provider-specific.

Furthermore, the system of the present invention is fully and conveniently upgradable. The system provides a static core on which newer applications can be built and innovative services can be launched without having to replace the capital infrastructure over time. Applications can be integrated with the core infrastructure using industry standard connections and protocols, as are generally known in the art.

Generally, the WISE architecture includes a series of interrelating layers. The central layers include a protocol stack layer, an adaptation layer, a network broker layer, an application interface layer and an application layer.

To achieve the foregoing objects, and in accordance with the purpose of the invention as broadly described herein, the present invention provides a plafform to enhance wireless carrier revenues and reduce network costs. The preferred embodiment of the present invention can be deployed in wireless carrier networks. will become more apparent from the following description.

### BRIEF DESCRIPTION OF THE DRAWINGS

FIG. 1 illustrates an exemplary wireless intelligent services engine architecture, wherein numerous functional layers are integrated, in accordance with one embodiment of the present invention.

FIGS. 2 and 3 show an exemplary functional overview of the system, in accordance with one embodiment of the present invention.

FIG. 4 presents hardware, software or a combination thereof that may be implemented in one or more computer systems or other processing systems to carry out the functionality of the present invention illustrated in FIGS. 1-3.

Other features of the present invention will become apparent from the following detailed description considered in connection with the accompanying drawings, which disclose multiple embodiments of the present invention. It should be understood, however, that the drawings are designed for the purpose of illustration only and not as a definition of the limits of the invention. Additional advantages and novel features of the invention will also become more apparent to those skilled in the art upon examination of the following or upon leaming by practice of the invention.

### DETAILED DESCRIPTION OF THE PRESENT INVENTION

The present invention provides an innovative OSS platform, which integrates signaling and billing technologies to allow real-time transactions and system assessment and/or management.

The system of the present invention provides an underlying platform layer that can remain as a static core and that can serve as the capital infrastructure for the provider. The static core generally includes two elements: signaling and billing that provide the underlying logic for most, if not all, services in the wireless communication industry. The present invention uniquely combines signaling protocols and real-time rating engines to form a core on which other applications are built and implemented. This core may also interface with third party applications and hardware. As a result, the present invention seamlessly integrates signaling, which is used to transmit data, probe network operations, and distribute information in real-time, with rating engine service and billing services to permit real-time assessment, management, and accounting of these services.

The system can be initially developed with one or more service layers, each of which performs services related to the wireless communication industry. The implementation of the system may be provider-specific to meet the exact needs of each provider.

The static core may be upgraded and expanded to accommodate the changing needs of each provider. For example, products, services, and applications, which can be rendered obsolete over time, can be replaced with state of the art applications on the system of the present invention. Generally, the replacement applications are interfaced with the system of the present invention using industry standard interfaces, which are generally known in the art. Accordingly, the system of the present invention can add multiple service layers to provide additional wireless communication services currently known or developed in the future.

Furthermore, the system of the present invention may be easily added to the existing capital infrastructure without high levels of adaptation or the need to replace significant amounts of hardware. Maintenance of the present system is also facilitated because vendor-specific information for each application and customizabon may not be required.

For the purposes of this application, Table 1 provides standard abbreviations for terms.

TABLE 1

| Abbreviation | Description |
|---|---|
| OSS | Operations Support System |
| ISUP | Integrated Services User Part |
| INAP | Intelligent Network Application Part |
| CAP | Camel Application Part |
| CAMEL | Customized Applications MobileEnhanced Logic |
| SAL | SS7 Adaptation Layer |
| NBL | Network Broker Layer |
| OSA | Open Services Access |
| XML | Extensible Markup Language |
| IDL | Interface Definition Language |
| MAP | Mobile Application Part |
| API | Application Program Interface |
| WISE | Wireless OSS Platform |
| WIN | Wireless Intelligent Network |
| MMS | Multimedia Messaging System |
| UMS | Unified Messaging System |
| EMS I | Enhanced Messaging System |

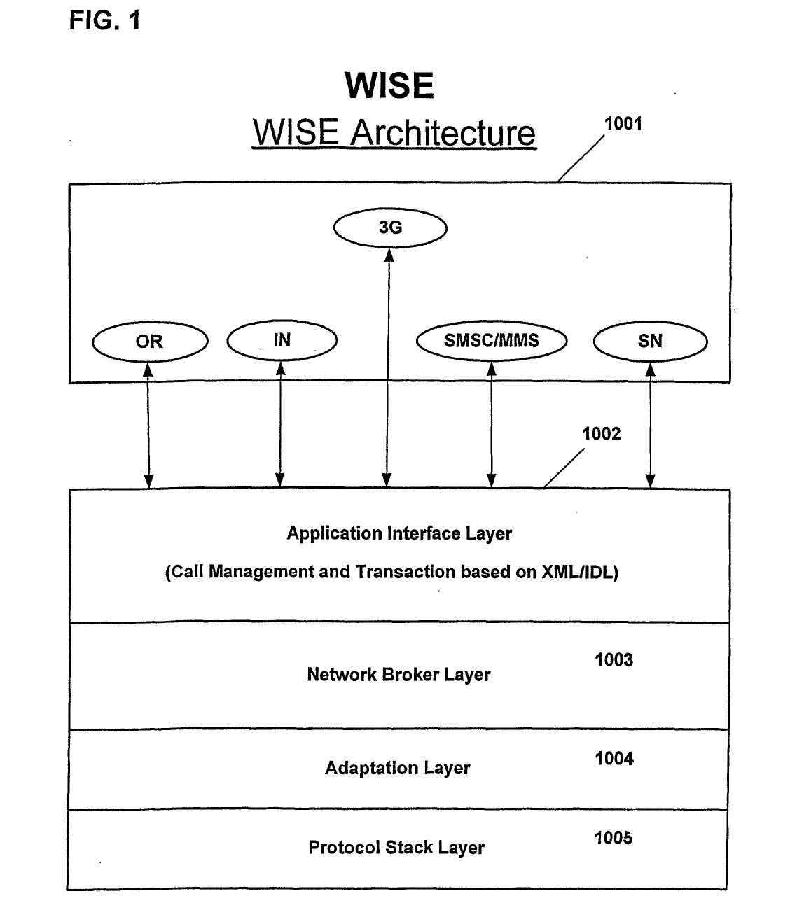

According to FIG. 1, which represents one embodiment of the WISE architecture, a protocol stack layer (PSL) 1005, an adaptation layer 1004, a network broker layer (NBL) 1003, an application interface layer (AIL) 1002 and an application layer 1001 are combined.

The top layer schematically in FIG. 1 is the application layer 1001, which provides the interface with external applications and interfaces with below layers via industry standard interfaces, such as interface definition language (IDL), open services access (OSA), and extensible mark-up language (XML). In this embodiment, the application layer may include external applications, such as, for example, multimedia messaging system (MMS), short message service center (SMSC), intelligent network (IN), Third Generation (3G) wireless systems, Service Node (SN), and Optimal Routing (OR).

The system of the present invention can run numerous applications. For instance, the system can run an intelligent network based mobile pre-paid platform with great rating flexibility and rapid service creation and deployment functionality, such as Mobile VPN, CUG, Mobile Office, and services generally described in the International Telecommunication Union—Telecommunication Standardization Sector (ITU-T) recommendations IN CS-1, CS-2, and CS-3. The system of the present invention can also run an application for an optimal routing functionality, which can be achieved through quickly and efficienty subscribing to and calling the call management APIs. Other applications capable of running on the system of the present invention include, for example, 3G services, dual IMSI-based roaming, missed call alerts, welcome SMS alerts while roaming, location-based services, mobile prepaid services based on service node technology, mobile pre-paid roaming applications using the call management APIs and rating APIs to provide pre-paid roaming services, SMS, EMS, UMS, and MMS services, postpaid and prepaid billing, and prepaid roaming and non-roaming based on CAMEL phase II, III, and IV.

The layer below the application layer 1001 is the application interface layer (AIL) 1002. The AIL 1002 provides the published application programming interfaces (APIs), such as call management and rating, which are generally known in the telecommunication arts. In one embodiment, the APIs are derived from industry standards, such as Parlay and XML.

The AIL 1002 is developed using the concepts of inter-operability and scalability. For example, in one variation of the present invention, interoperability is facilitated by using Common Object Request Broker Architecture (CORBA®). CORBA® is a vendor-independent architecture and infrastructure that computer applications use to work together over networks. Using the standard protocol IIOP, a CORBA-based program from any vendor, on almost any computer, operating system, programming language, and network, can interoperate with a CORBA-based program from the same or another vendor, on almost any other computer, operating system, programming language, and network. Other examples of interoperability include XML, java native interface (JNI), and Interface Definition Language (IDL).

The AIL 1002 may interface with the layers below via industry standard interfaces, such as IDL, OSA, and XML. In one embodiment, the APIs are derived from Industry standards, such as Parlay and XML.

In an embodiment of the present invention according to FIG. 1, the layer schematically below the AIL 1002 is the network broker layer (NBL) 1003. The functionality of this layer is to interface with the network layer and to specified access components. The specified access components are specific protocols, such as wireless intelligent network (WIN), integrated services user part (ISUP), intelligent network application part (INAP), mobile application part (MAP), Transaction Capabilities Application Part (TCAP), Signaling Connection Control Part (SCCP) and/or customized applications mobile enhanced logic (CAMEL) application part (collectively known as “CAP”). In one variation, there are specified access components to the wireless domain (e.g., Wireless Access Components).

The applications register and subscribe to the services offered by the NBL 1003. The NBL 1003 is capable of addressing various protocols under signaling. In one variation, the 3G related applications are registered and subscribed to telecom access components. To support 3G requirements, for example, both SS7 and IP protocols are subscribed to and registered by applications.

Additionally, the NBL 1003 interfaces with vendor-specific APIs transparent to the application (e.g. NetStructure, manufactured by Intel of Santa Clara, Calif. and Opencall manufactured by Hewlett Packard of Palo Alto, Calif.). Additionally, in one variation, the NBL 1003 also supports network management functionality, so as to ensure that proper fault and alarm reporting is carried out apart from having the flexibility in managing and fixing faults. In another variation, the NBL 1003 also provides network statistics based on the applications subscribed thereon.

Schematically below the network broker layer 1003 shown in to FIG. 1 is the adaptation layer 1004. The purpose of the adaptation layer 1004 is to convert the various APIs (e.g., SS7) provided by each vendor to a common framework of messages. In one variation involving SS7, for example, any new SS7 stack can be implemented quickly and efficiently. This adaptation layer 1004, typically, avoids the need to test the complete functionality of the entire system after each software/hardware change.

As shown in FIG. 1, the protocol stack layer 1005 is schematically disposed below the adaptation layer 1004. The purpose of the protocol stack layer 1005 is to facilitate interconnection and exchange of information between users in a communications system. The hardware and software functions of the SS7 protocol are divided into functional abstractions called “levels.” These levels map loosely to the Open Systems Interconnect (OSI) 7-layer reference model defined by the International Standards Organization (ISO).

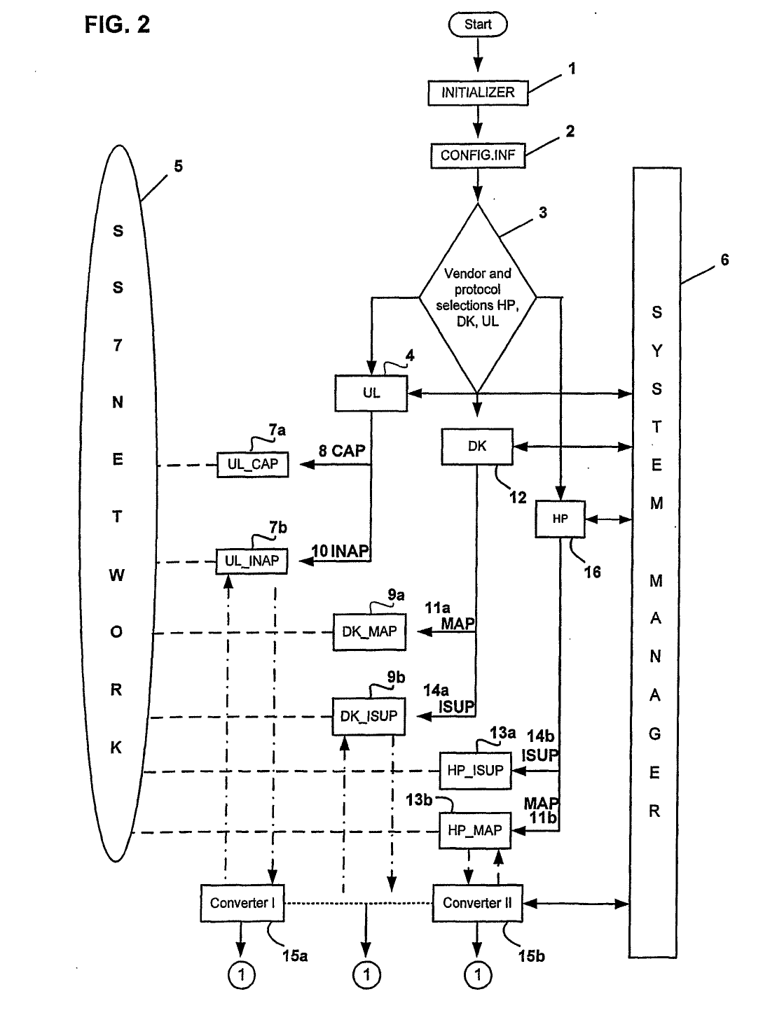

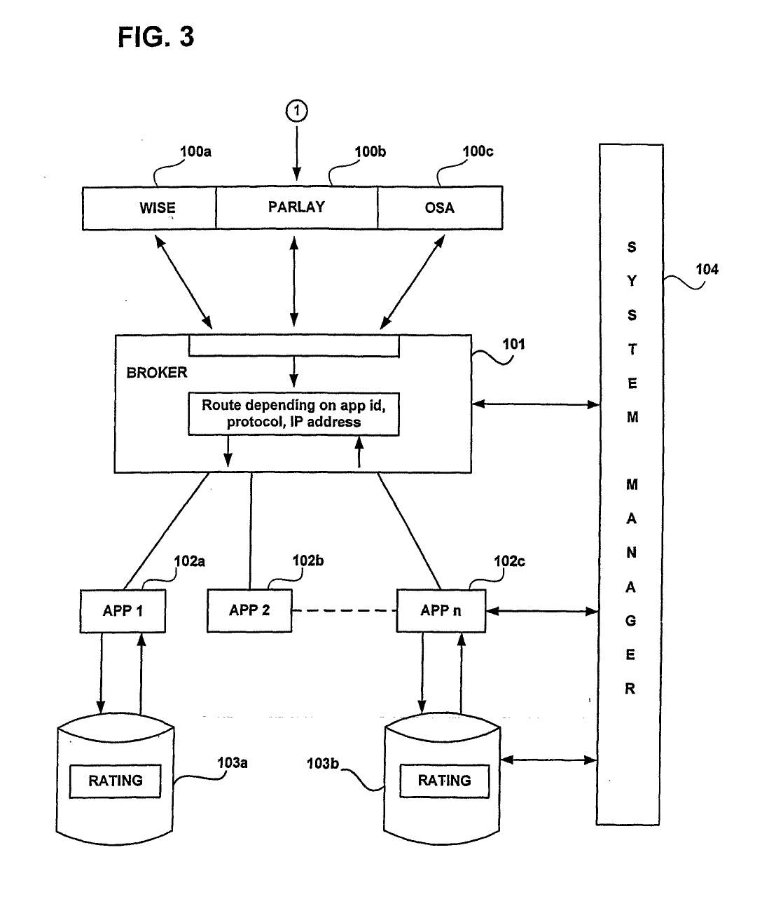

FIGS. 2 and 3 provide functional overviews of the system of the present Invention. In FIG. 2, the process beings with the initializer 1 executing the process(es) obtained from a file containing configuration information, such as config.ini 2 (also referred to herein interchangeably as “configuration information”). The initializer also may start or initialize the various protocol stacks configured in the config.ini 2 file.

Typically the config.ini 2 file stores application information. For example, the config.ini 2 (or an equivalent file) includes the number of applications, the name of applications, and ID for applications. The config.ini 2 file may include stack information, including the type of stack and the protocol used. Example stacks include Opencall (herein referred to as “HP”), NetStructure (herein referred to as “DK”), and Signalware (manufactured by Ulticom, Inc. of Mt. Laurel, N.J. and herein referred to as “ULTICOM”). Example protocols Include ISUP-HP, MAP-HP, ISUP-DK, MAP-DK, CAP-ULTICOM, and INAP-ULTICOM.

Additionally, in yet another variation, the config.ini 2 file includes converter information. The converter information may include, for example, the number of converters per stack and the converter type. The converter type information may Include the socket and/or pipe.

The config.ini 2 file may also include fail-safe information. The fail-safe information includes stack level fail-safe information (e.g., HP, DK, or ULTICOM) and the converter level fail-safe information. The converter level fail-safe information may include this information for each converter level (e.g., 1, 2, 3, . . .n).

The config.ini 2 file may also include: 1) a broker configuration, which may include information, such as an application ID, protocol ID, application IP address; 2) broker level fail-safe information, which may include the broker ID; 3) API information and/or format, which may include interface information, such as the WISE format, the PARLAY format, or the OSA format; and 4) information on IP addresses, which may include whether the address is active or in stand by.

In decision box 3, the particular vendor and/or protocol for the desired process are selected. The vendor and protocol selections may include, for example, HP 16, DK 12, and ULTICOM 4(also referred to herein as “UL”).

After a vendor and protocol is selected, the initializer starts the corresponding stacks. ULTICOM 4 may be one of the stacks, including protocols, started by the initializer 1. The ULTICOM 4 stack(s) communicate in the SS7 network 5 using, for example, E1/T1 interfaces, via CAP 8 and INAP 10. Accordingly, this leads to UL_CAP 7a and UL_INAP 7b.

Additionally DK 12 may be one of the stacks, including protocols, started by the initializer 1. The DK 12 stacks communicate in the SS7 network using E1/T1 interfaces, via ISUP 14a and MAP 11a. Accordingly, this leads to DK_ISUP 9a and DK_MAP 9a.

HP 16 may also be one of the stocks, including protocols, started by the initializer 1. The HP 16 stacks communicate in the SS7 network 5 using E1/T1 interfaces, via ISUP 14b and MAP 11b. Accordingly this leads to HP_ISUP 13a and DK_MAP 13b.

Converters 15a and 15b, for example, receive the message from the various stacks, e.g., UL 4, DK :12, and HP 16, and convert them to configured API formats. In one variation, as shown in FIG. 3, the three types of API formats generated are WISE 100a, PARLAY 100b, and OSA 100c, which are the formats in the config.ini 2 file.

The converters may operate under a fail-safe configuration, if configured to do so in the config.ini 2. The number of converters 15a and 15b, as shown in FIG. 2, is dependent on the traffic the system is designed to support. Under the fail-safe condition one converter 15a and 15b may execute in each machine/system. In some embodiments, a pair of converters may execute in the other machine/system (active and stand by servers).

Once the converters 15a and 15b receive the messages from the stacks and convert them to configured API formats, the API formats are forwarded to the broker 101, as shown in FIG. 3. All the applications register with the broker 101 using an application ID, a protocol ID, and an IP address.

The system manager 6 (FIG. 2) and 104 (FIG. 3) serves as the system administrator (interchangeably referred to herein as “monitor”) to ensure the functionality of each element, i.e., the broker 101, the converters 15a and 15b, and the stacks 4, 12, and 16. In the event that there is a malfunction, the system manager 6 and 104 identifies and remedies the malfunction. Additionally, the system manager 6 and 104 may alert the operator of the malfunction with an alarm. In one variation, the system manager 6 and 104 can automatically initiate additional processes to ensure high availability of the services.

The broker 101 routes the APIs to the appropriate application 102a, 102b, and 102c based on the application ID, the protocol ID, and the IP address. In one variation, application 102a addresses pre-paid applications. In this variation, the application interfaces with the rating engine 103a with standard SQL statements. In another variation, application 102a is a messaging application. Thus, multiple applications 102a, 102b, and 102c can be developed within the same broker 101.

The following illustrates three examples of implementations and resulting effectiveness of the system of the present Invention. The first two examples are comparative examples of conventional systems and the problems associated therewith. The third example is illustrative of the how the system of the present invention assists providers and improves upon the conventional systems.

Comparative Example 1. A large wireless communications provider uses multi-vendor platforms as the infrastructure to support wireless communication and related services. The provider uses numerous services, which are functional on separate hardware. Table 2 lists the services and platforms that are used by the provider.

TABLE 2

| Services | Equipment/Platform | Vendor |
|---|---|---|
| Mobile Voice Telephony | MSC/VLR & HLR | Siemens, Nokia |
| | | and Ericsson |
| Data (SMS) | Unix | Nokia |
| GPRS | Unix | Nokia |
| Prepaid IN | Unix | Siemens |
| Prepaid IN | Windows | Vendor 1 |
| Prepaid Roaming | Windows | Vendor 2 |
| Optimal Routing | Windows | Vendor 3 |
| Welcome SMS | Windows | Vendor 4 |
| Postpaid Billing | Sun Solaris | Vendor 5 |

Table 2 presents a typical case in which the provider uses multiple plafforms/equipment to support various services. As a result, the provider must ensure complete and accurate integration of these services with one another to provide 100% optimization to the end user. In the event that the provider is unable to provide 100% optimization, the provider has limited options to address the situation and attempt to reach 100% optimization. For instance, the provider can obtain support from each vendor to determine whether each vendor's services are operational and optimized. However, each vendor is only able to address the problems associated with the vendor-specific application. A vendor of one protocol cannot typically address the problems associated with another protocol. Thus, the provider must rely on numerous vendors for support. By relying on the various vendors for assistance, the provider invests substantial amount of time and resources. In practical terms, addressing problems in this manner (e.g., obtaining expert support from each vendor) is typically associated with significant costs. In addition, the provider is typically unable to obtain information from vendors on how the individual applications should be integrated with one another. Therefore, having multiple platforms/equipment installed at the provider invites huge network integration costs and the likelihood of decreased revenues due to a high turnover of subscribers, i.e., unsubscribing from the services of the carrier.

Comparative Example 2. A large provider uses a single vendor platform as the infrastructure to support various services offered by the provider. Table 3 illustrates the various services offered by the provider and the corresponding platforms used to support the services.

TABLE 3

| Services* | Equipment/Platform | Vendor |
|---|---|---|
| Mobile Voice Telephony | MSCNLR & HLR | Siemens |
| Data (SMS) | Unix | Single Vendor |
| GPRS | Unix | Single Vendor |
| Prepaid IN | Unix | Single Vendor |
| Prepaid Roaming | Unix | Single Vendor |
| Optimal Routing | Unix | Single Vendor |
| Welcome SMS | Unix | Single Vendor |
| Postpaid Billing | Unix I | Single Vendor |

Thus, Table 3 depicts a typical case where the provider installed various services of a single vendor on separate hardware to support those services. In this example, the maintenance costs of such hardware is prohibitively high, and the provider is accordingly extremely dependent on the single vendor. Additionally, the provider is limited to services that are provided by the single vendor, thereby limiting the scope of the providers' services to those offered by the single vendor. Moreover, the problem of limited scope of services is further exacerbated because the single vendor infrastructure does not permit third-party services to be implemented. The net result for the provider includes limited services offered, restricted revenue growth, and a potential loss of customers to market competitors providing a wider scope and range of services.

Example 3. The following example involves a large provider using the platform of the present invention, in accordance with one embodiment, as infrastructure to support various services. In this variation, the infrastructure is hardware and operating system independent, thereby increasing the versatility and applicability of the platform. Table 4 presents the various services provided the provider in this embodiment.

TABLE 4

| Services* | Equipment/Platform | Vendor |
|---|---|---|
| Mobile Voice Telephony | MSC/VLR & HLR | Siemens |
| Data (SMS) | OS Independent | Single Vendor/ |
| GPRS | (Unix, Solaris, | Multi Vendor |
| Prepaid IN | Linux) HM | (Multi Vendor |
| Prepaid Roaming | independent (HP, | for hardware |
| Optimal Routing | SUN, INTEL) | and applications |
| Welcome SMS | | is possible), but |
| Postpaid Billing | | not recommended |
| Option/Interface for Carrier | | |
| to add 3rd party services | | |

Table 4 depicts a typical case where the Wireless carrier has a single vendor and has installed scaleable hardware that supports various services. The infrastructure provided by the present invention creates an interface that can communicate with (e.g., “plug into”) any numerous third party services that operate in universally accepted formats and industry standard interfaces (e.g., XML, CORBA).

Thus, with the implementation of the present Invention, the provider obtains a number of advantages, including decreased maintenance costs and a resulting minimization of network costs. It should be noted that maintenance of the infrastructure does not require vendor-specific assistance or hardware.

The provider also has an option to increase services developed by third parties on the existing platform (single or multiple hardware boxes). This potential for expansion provides the carrier with flexibility to increase services and/or provide additional services to its customers, thereby enhancing revenue and providing a basis for a substantial decrease in network costs.

The system in Example 3, as compared to the conventional systems in Examples 1 and 2, allows providers to reduce capital expenses and operational expenses. This reduction in expenses is significant when compared to the industry standard costs for implementing and maintaining a core infrastructure. Accordingly, as the costs decrease, the provider is able to increase revenue, or at the least, pass the financial benefit to the end user maintaining the same similar revenues.

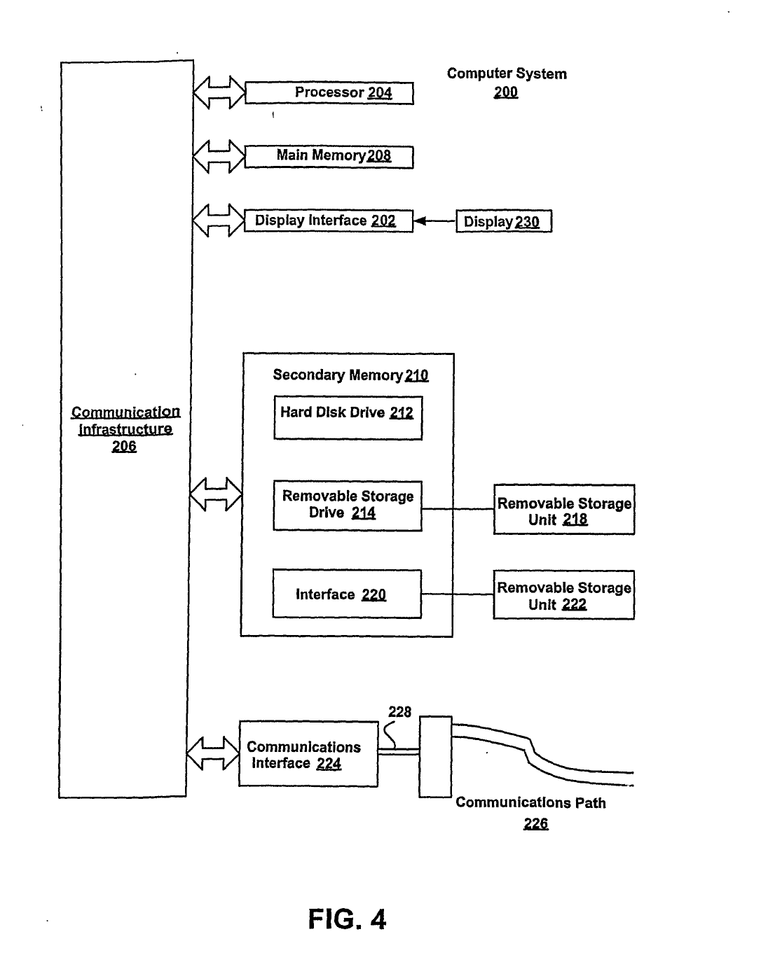

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system is shown in FIG. 4.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that transmits graphics, text, and other data from the communication infrastructure 206 (or from a frame buffer not shown) to the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads' from and/or writes to a removable storage unit 218 in a well-known manner. Removable storage unit 218 may represent a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other devices for allowing computer programs or other instructions to be loaded into computer system 200. Such devices may Include, for example, removable storage unit 222 and interface 220. Removable storage unit 222 and interface 220 may include a program cartridge and cartridge interface (such as that found in video game devices), a removable memory chip (such as an erasable programmable read only memory (EPROM), or programmable read only memory (PROM)) and associated socket, etc., which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, removable storage drive 222, RAM, ROM, EPROM, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, removable storage drive 222, RAM, ROM, EPROM, hard drive 212, or communications interface 224. The control logic (software), when executed by the processor 204, causes the processor 204 to perform the functions of the invention as described herein. In another embodiment, the invention Is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While there has been described what are at present considered to be preferred embodiments of the present invention, it will be understood that various modifications may be made thereto, and it is intended that the appended claims cover all such modifications as fall within the true spirit and scope of the invention. Other modifications will be apparent to those skiJled In the art.

What is claimed is:

1. A system for providing core infrastructure in wireless communication, the system comprising an operating system, the operating system comprising:
a protocol stack layer;
an adaptation layer, schematically disposed above the protocol layer;
a network broker layer functionally connected to the adaptation layer; and
an application interface layer, wherein the application interface layer is functionally connected to the network broker layer and interfaces with external applications.

2. The system according to claim 1, wherein the operating system includes signaling and billing elements seamlessly integrated in real-time.

3. The system according to claim 1, wherein the operating system is customizable.

4. The system according to claim 1, wherein the operating system is scaleable.

5. The system according to claim 1 wherein the operating system upgradeable with applications using industry standards.

6. The system according to claim 1, wherein the external applications are any one selected from a group consisting of multimedia messaging system, short messaging service center, intelligent network, third generation systems, and OR.

7. The system according to claim 1, wherein the application interface layer interfaces via the industry standard formats which include any one selected from the group consisting of interface definition language, open services access, and extensible markup language.

8. The system according to claim 1, wherein the network broker layer interfaces with access components.

9. The system according to claim 1, wherein access components include one protocol selected from the group consisting of wireless intelligent network, integrated services user part, intelligent network application part, customized applications mobile enhanced logic application part, and mobile application part.

10. The system according to claim 1, the system further comprising:
an adaptation layer serving to convert application programming interfaces from each respect vendor to a common framework of messages.

11. A system for providing core infrastructure in the wireless communication, the system comprising:
a file having configuration information;
an initializer that executes the file having configuration information;
a plurality of protocol selections initiated by the initializer and communicating with a network;
a converter receiving messages from the plurality of protocol selections and converting the messages to an application programming interface format;
a broker receiving and registering the applications from the converter; and
a system manager monitoring the functions of any one of the group consisting of the initializer, file having configuration information, the plurality of protocol selections, the converter and the broker.

12. A system according to claim 11, wherein the system manager raises an alarm upon failure of one selected from the following group consisting of the broker, the converter, the plurality of protocol selections, the initializer, and the file having configuration information.

13. A system according to claim 11, wherein the broker registers the applications using any one selected from the group consisting of an application identification, protocol identification, and an IP address.

14. A system according to claim 11, wherein file having configuration information includes one selected from a group consisting of application information, stack information, converter information, and fail-safe information.

15. A system according to claim 11, wherein the converter converts messages to API formats from one selected from the following group consisting of WISE, Parlay, or OSA.

16. A system according to claim 15, wherein the converter converts to WISE.

17. A system according to claim 14, wherein stack information is one of selected from the group consisting of stack type and protocol used.

18. A system according to claim 17, wherein the protocol is one selected from the group consisting of ISUP, MAP, ISUP, MAP, CAP, and INAP.

19. A system according to claim 14, wherein the converter information is one selected from the group consisting of the number of converters and converter type.

20. A system according to claim 19, wherein the converter information is one selected from the group consisting of socket and pipe.

21. A system according to claim 14, wherein the fail-safe information is one selected from the group consisting of stack level fail-safe, converter level fail-safe, broker configuration, broker level fail-safe, API information, and IP address.

22. A system according to claim 14, wherein the broker level fail-safe comprises a broker ID.

23. A system according to claim 14, wherein the IP address is active.
